(19) United States
(12) Patent Application Publication
(10) Pub. No.: US 2025/0153401 A1
(43) Pub. Date: May 15, 2025

(54) METHOD FOR PRODUCING SELF-ASSEMBLY POLYMER MEMBRANE BY NON-SOLVENT INDUCED FILM FORMATION AND POLYMER MEMBRANE PRODUCED THEREBY

(71) Applicant: INDUSTRY-ACADEMIC COOPERATION FOUNDATION, YONSEI UNIVERSITY, Seoul (KR)

(72) Inventors: Jong Hak KIM, Seoul (KR); Du Ru KANG, Seoul (KR)

(21) Appl. No.: 18/941,918

(22) Filed: Nov. 8, 2024

(30) Foreign Application Priority Data
Nov. 9, 2023 (KR) 10-2023-0154086
May 9, 2024 (KR) 10-2024-0061060

(51) Int. Cl. B29C 41/00; B29C 41/08; B29C 41/12; B29C 41/14; B29K 61/00; C09D 139/04; C25B 13/08; H01M 8/0221

(52) U.S. Cl. CPC B29C 41/003; C09D 139/04; C25B 13/08; H01M 8/0221; B29C 41/08; B29C 41/12; B29C 41/14; B29K 2061/00

(57) ABSTRACT

An embodiment relates to a method for producing a self-assembly polymer membrane by non-solvent induced film formation (NIFF), the method including: (a) preparing a polymer solution by mixing an ionized polymer with an organic solvent, (b) preparing a substrate on which a polymer solution coating layer is formed by coating the polymer solution on a substrate and (c) forming an ionized polymer membrane by immersing the substrate on which the polymer solution coating layer is formed in a non-solvent without going through a drying process under elevated temperature conditions. Accordingly, it is possible to produce a nonporous, dense polymer membrane in an efficient way that saves time and energy.

### CROSS-REFERENCE TO RELATED APPLICATION

This application claims the benefit of Korean Patent Application No. 10-2023-0154086 filed on Nov. 9, 2023, and Korean Patent Application No. 10-2024-0061060 filed on May 9, 2024, in the Korean Intellectual Property Office, the disclosure of which are hereby incorporated by reference herein in its entirety.

### BACKGROUND

The disclosure relates to a method for producing a high-density polymer membrane usable as an ion exchange membrane and a polymer membrane produced thereby.

The ion exchange membrane has a nonporous dense structure and is composed of a polymer electrolyte having a positive or negative charge. It is widely used in various electrochemical devices such as fuel cells, water electrolysis, electrodialysis cells, and redox flow batteries. Among them, anion exchange membranes (AEMs) are attracting attention due to the advantage of being able to use inexpensive non-precious metal electrocatalysts based on non-platinum group metals in alkaline operating environments.

Various polymers such as polyethylene oxide (PEO), polyvinyl alcohol (PVA), and poly (2,6-dimethyl-1,4-phenylene oxide) (PPO) are used for anion exchange membranes (AEMs), and recently, poly (aryl piperidine) (PAP) membranes composed of aromatic phenyl groups and quaternary piperidine rings have been actively studied due to their excellent mechanical properties and high cell performance.

The conventionally used process is the solution casting (SC) process, which is a method used to produce transparent, dense, and self-assembly polymer films. A solution casting method is characterized by producing a dense, pore-free polymer membrane by casting a homogeneous polymer solution into a flat container and then evaporating the solvent at high temperatures.

However, if a polymer is only soluble in high-boiling organic solvents such as DMSO, NMP, DMF, and DMAc, the process of manufacturing a dense membrane by completely removing the residual solvent through solution casting (SC) takes a long time and requires multi-stage high-temperature vacuum treatment. This is because bubbles or defects occur due to rapid evaporation of the solvent.

Meanwhile, in the conventional membrane manufacturing polymer system using non-solvent induced phase separation (NIPS), there was a problem that when the polymer solution was immersed in a non-solvent, phase separation occurred, forming an asymmetric porous membrane, and causing the membrane become cloudy.

### RELATED ART DOCUMENT

(Patent document 1) Korean Patent Registration No. 10-2509388
(Patent document 2) Chinese Patent Publication No. 108570157 A

### SUMMARY

The disclosure, which is to solve the problems of conventional solution casting (SC) and non-solvent induced phase separation (NIPS), is to provide a method for producing a non-porous, dense, and transparent polymer membrane, wherein unlike solution casting (SC), time and energy are saved by not going through a drying process after polymer solution coating, and, unlike non-solvent induced phase separation (NIPS), despite a process of immersing a polymer solution coating layer in a non-solvent without drying, phase separation, making the membrane cloudy and forming an uneven porous structure, is not caused.

According to an aspect of the disclosure, the method may include:
(a) preparing a polymer solution by mixing an ionized polymer with an organic solvent having a boiling point of 150° C. or higher;
(b) preparing a substrate on which a polymer solution coating layer is formed by coating the polymer solution on a substrate; and
(c) forming an ionized polymer membrane by immersing the substrate on which the polymer solution coating layer is formed in a non-solvent without going through a drying process under elevated temperature conditions.

In (a), the organic solvent having a boiling point of 150° C. or higher may be one selected from among dimethyl sulfoxide (DMSO), dimethylformamide (DMF), N-methyl-2-pyrrolidone (NMP), and dimethylacetamide (DMAC).

The ionized polymer may be an ionized form of a polymer of one selected from poly(aryl piperidinium), poly(4-vinylbenzyl-b-styrene) (PVBC-b-PS), poly(ethylene oxide) (PEO), poly(vinyl alcohol) (PVA), poly(2,6-dimethyl-1,4-phenylene oxide) (PPO), polyethylene (PE), polypropylene (PP), polychloromethylstyrene (PCMS), poly(epichlorohydrin), poly(acrylic acid) (PAA), chitosan, polybenzimidazole (PBI), poly(vinylbenzyl chloride) (PVBC), poly(γ-methacryloxypropyl trimethoxy silane), poly(methyl acrylate) (PMA), polyethyleneimine (PEI), poly(styrenesulfonic acid) (PSSH), polycarylonitrile (PAN), polyphenylene, polyethersulfone (PES), polysulfone (PSF), and nafion.

The ionized polymer may be a quaternized poly(aryl piperidinium) (q-PAP) represented by Structural Formula 1.

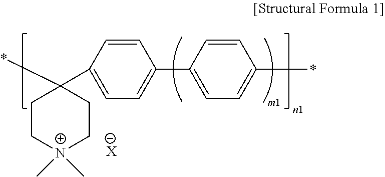

In Structural Formula 1,
m1 is a repeating unit number, which is an integer from 1 to 10,
n1 is a repeating unit number, which is an integer from 50 to 200, and
X⁻ is a hydroxide ion (OH⁻) or a chloride ion (Cl⁻).

Preferably, in Structural Formula 1,
m1 may be a repeating unit number, which is 2 or 3,
n1 may be a repeating unit number, which is an integer from 100 to 150, and
X⁻ may be a hydroxide ion (OH⁻) or a chloride ion (Cl⁻). In (a), the quaternized poly(aryl piperidinium)(q-PAP) may be produced by adding a halogenated alkyl to poly(aryl piperidinium)(PAP) represented by Structural Formula 2, according to a Menshutkin reaction.

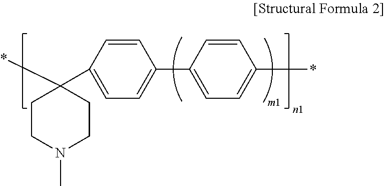

In Structural Formula 2,
m1 is a repeating unit number, which is an integer from 1 to 10, and
n1 is a repeating unit number, which is an integer from 50 to 200.

The poly(aryl piperidinium) (PAP) represented by Structural Formula 2 may be polymerized according to a Friedel-Crafts condensation reaction with N-methyl-4-piperidone using a monomer represented by Structural Formula 3 under an acid catalyst.

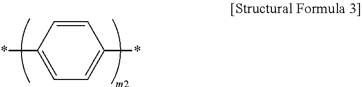

m2 is a repeating unit number, which is an integer from 2 to 10.

The monomer represented by Structural Formula 3 may be p-terphenyl or p-quaterphenyl.

The ionized polymer may be a quaternized poly(4-vinylbenzyl-b-styrene) (PVBC-b-PS) block copolymer represented by Structural Formula 5.

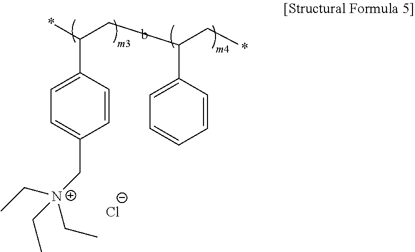

In Structural Formula 5,
*41m3 and m4 are each independently a repeating unit number, which is an integer from 20 to 150.

The acid catalyst may use trifluoroacetic acid and trifluoromethanesulfonic acid.

In (a), the polymer solution may contain 20 to 40 wt % of the ionized polymer.

Preferably, the organic solvent of (a) may be dimethyl sulfoxide (DMSO), and the non-solvent of (c) may be water.

In (b), the polymer solution coating layer may be formed to a thickness of 50 to 400 pm.

In (b), the coating may be performed by any one scheme selected from doctor blade, spin coating, dip coating and spray coating.

In (c), the coating layer of the polymer solution may form a gel region by gelation at a contact surface with the non-solvent.

The gel region may prevent the non-solvent from penetrating into the ionized polymer and allow the organic solvent to escape from the ionized polymer.

The method may further include, after (c), (d) ion-exchanging a counter ion of the ionized polymer membrane after the ionized polymer membrane is spontaneously separated from the substrate.

The ion exchange may exchange the counter ion with a chloride ion (Cl−) or hydroxide ion (OH−) by adding sodium chloride (NaCl) or sodium hydroxide (NaOH).

According to another aspect of the disclosure, provided is a polymer membrane produced according to the method for producing a self-assembly polymer membrane by non-solvent induced film formation (NIFF).

The polymer membrane may be used as an ion exchange membrane.

The ion exchange membrane may be an anion exchange membrane (AEM).

According to another aspect of the disclosure, provided is an electrochemical device including the polymer membrane.

The electrochemical device may be one selected from an alkaline water electrolysis device, a redox flow battery, and a fuel cell.

The method for producing a self-assembly polymer membrane by non-solvent induced film formation (NIFF) of the disclosure introduces the same process as the conventional non-solvent induced phase separation (NIPS) method; however, a liquid-liquid phase separation phenomenon does not occur when a polymer solution coating layer is immersed in a non-solvent; a gel layer is formed at an interface, thereby blocking the penetration of the non-solvent into the polymer solution coating layer; and a solvent in the polymer solution coating layer quickly escapes out of the system, thereby forming a non-porous, dense membrane.

The polymer membrane produced according to the method for producing a self-assembly polymer membrane by non-solvent induced film formation (NIFF) of the disclosure is similar to the membrane produced by the conventional solution casting (SC) process in various physical and chemical properties, despite the fact that the process of drying the polymer solution is omitted unlike the conventional solution casting (SC) process; therefore, the method for producing a self-assembly polymer membrane by non-solvent induced film formation (NIFF) of the disclosure is very efficient in terms of time and energy savings.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A and 1B are each a schematic diagram of a production process (1A) of quaternized poly(aryl piperidinium) (q-PAP) according to the conventional solution casting (SC) of Comparative Examples 1 and 2 and a production process (1B) of quaternized poly(aryl piperidinium) (q-PAP) according to non-solvent induced film formation (NIFF) of Examples 1 and 2;

FIGS. 2A, 2B, and 2C are each a photograph (2A) of a q-PTP membrane produced by Example 1, a photograph (2B) of a q-PVBC-b-PS membrane produced by Example 3, and a cross-sectional SEM image of a q-PVBC-b-PS membrane;

FIGS. 3A, 3B, 3C, and 3D are each a ternary phase diagram and dynamic analysis result of a polymer/solvent/non-solvent system according to Experimental Example 1;

FIGS. 4A and 4B show a TEM image (4A) of a q-PTP polymer and a TEM image (4B) of a q-PQP polymer according to Experimental Example 3;

FIG. 5 shows FTIR spectra of PTP, q-PTP, PQP, and q-PQP polymers according to Experimental Example 3;

FIG. 6 shows TGA graphs of q-PTP and q-PQP polymers according to Experimental Example 3;

FIGS. 7A and 7B show an SEM image (7A) of the cross-section of a q-PQP membrane and an SEM image (7B) of the surface of a q-PQP membrane according to Experimental Example 4;

FIG. 8 is a stress-strain curve for a q-PAP membrane according to Experimental Example 4; and

FIG. 9 is hydroxide ion (OH⁻) conductivity measurement results, according to Experimental Example 4, of NIFF-based q-PAP membranes of Examples 1 and 2 and SC-based q-PAP membranes of Comparative Examples 1 and 2.

### DETAILED DESCRIPTION

Hereinafter, various aspects and various implementations of the disclosure will be described in more detail. Hereinafter, embodiments of the disclosure will be described in detail with reference to the accompanying drawings so that those skilled in the art can easily carry out the disclosure. However, the following description is not intended to limit the disclosure to specific embodiments, and if it is determined that a specific description of related known technologies may obscure the gist of the disclosure in explaining the disclosure, the detailed description thereof will be omitted. The terms used herein are only used to describe specific embodiments, and are not intended to limit the disclosure. The singular expression includes the plural expression unless the context clearly indicates otherwise. In this application, the terms “include” or “have” are intended to specify the presence of a feature, number, step, operation, component, or combination thereof described in the specification, but should be understood as not excluding in advance the possibility of the presence or addition of one or more other features, numbers, steps, operations, components, or combinations thereof.

Hereinafter, a method for producing a self-assembly polymer membrane by non-solvent induced film formation (NIFF) of the disclosure will be described.

A method for producing a self-assembly polymer membrane by non-solvent induced film formation (NIFF) according to the disclosure includes: (a) preparing a polymer solution by mixing an ionized polymer with an organic solvent; (b) preparing a substrate on which a polymer solution coating layer is formed by coating the polymer solution on a substrate; and (c) forming an ionized polymer membrane by immersing the substrate on which the polymer solution coating layer is formed in a non-solvent without going through a drying process under elevated temperature conditions.

Hereinafter, the method for producing a self-assembly polymer membrane by non-solvent induced film formation (NIFF) of the disclosure will be specifically described step by step.

First, a ionized polymer is mixed with an organic solvent having a boiling point of 150° C. or higher to produce a polymer solution (step a).

The ionized polymer may be an ionized form of a polymer of one selected from poly(aryl piperidinium), poly(4-vinylbenzyl-b-styrene) (PVBC-b-PS), poly(ethylene oxide) (PEO), poly(vinyl alcohol) (PVA), poly(2,6-dimethyl-1,4-phenylene oxide) (PPO), polyethylene (PE), polypropylene (PP), polychloromethylstyrene (PCMS), poly(epichlorohydrin), poly(acrylic acid) (PAA), chitosan, polybenzimidazole (PBI), poly(vinylbenzyl chloride) (PVBC), poly(γ-methacryloxypropyl trimethoxy silane), poly(methyl acrylate) (PMA), polyethyleneimine (PEI), poly(styrenesulfonic acid) (PSSH), polycarylonitrile (PAN), polyphenylene, polyethersulfone (PES), polysulfone (PSF), and nafion.

Preferably, the ionized polymer may be a quaternized poly(aryl piperidinium) (q-PAP) represented by Structural Formula 1.

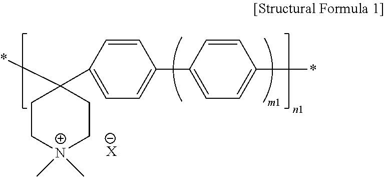

In Structural Formula 1,
m1 is a repeating unit number, which is an integer from 1 to 10, and
n1 is a repeating unit number, which is an integer from 50 to 200, and
X⁻ is a hydroxide ion (OH⁻) or a chloride ion (Cl⁻).

Preferably, in Structural Formula 1,
m1 may be a repeating unit number, which is an integer from 1 to 5, and
n1 may be a repeating unit number, which is an integer from 100 to 150, and
X⁻ may be a hydroxide ion (OH⁻) or a chloride ion (Cl⁻).

More preferably, in Structural Formula 1,
m1 may be a repeating unit number, which is 2 or 3,

The organic solvent may be an organic solvent having a high boiling point of 150° C. or higher, and preferably, may be one selected from among dimethyl sulfoxide (DMSO), dimethylformamide (DMF), N-methyl-2-pyrrolidone (NMP), and dimethylacetamide (DMAC). The boiling points of the organic solvents are respectively DMSO 189° C., NMP 202° C., DMF 153° C., and DMAc 165° C. It is more preferable that the organic solvent is dimethyl sulfoxide (DMSO).

The quaternized poly(aryl piperidinium) (q-PAP) may be produced according to the production method below.

Specifically, for production thereof, a halogenated alkyl may be added to poly(aryl piperidinium)

(PAP) represented by Structural Formula 2 and a tertiary amine may be quaternized according to a Menshutkin reaction.

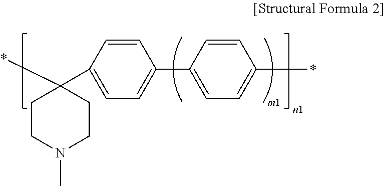

In Structural Formula 2,
m1 may be a repeating unit number, which is an integer from 1 to 10, and
n1 is a repeating unit number, which is an integer from 50 to 200.

The halogenated alkyl may be represented by RX, R may be a linear or cyclic alkyl group having 1 to 20 atoms, specifically, a methyl group, an ethyl group, an n-propyl group, an iso-propyl group, an n-hexyl group, an n-octyl group, etc., and X may be chlorine, bromine, or iodine. Preferably, the halogenated alkyl may be methyl iodide (CH₃I).

In addition, poly(aryl piperidinium) (PAP) represented by Structural Formula 2 may be produced according to a production method below.

Specifically, for polymerization thereof, a monomer represented by Structural Formula 3 may have a Friedel-Crafts condensation reaction with N-methyl-4-piperidone under an acid catalyst.

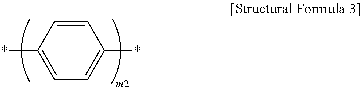

m2 is a repeating unit number, which is an integer from 2 to 10.

The monomer represented by Structural Formula 3 is preferably p-terphenyl or p-quaterphenyl.

According to another implementation of the disclosure, the ionized polymer may be a quaternized poly(4-vinylbenzyl-b-styrene) (PVBC-b-PS) block copolymer represented by Structural Formula 5.

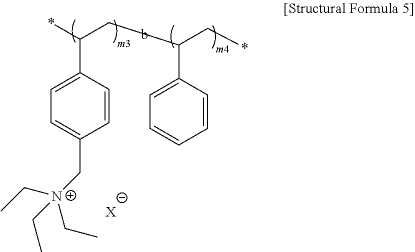

In Structural Formula 5,
m3 and m4 may be each independently a repeating unit number, which is an integer from 20 to 150, and
X⁻ may be a hydroxide ion (OH⁻) or a chloride ion (Cl⁻).

Preferably, in Structural Formula 5,
m3 and m4 may be each independently a repeating unit number, which is an integer from 50 to 100, and
X⁻ may be a chloride ion (Cl⁻).

The acid catalyst may be at least one selected from trifluoroacetic acid and trifluoromethanesulfonic acid.

The polymerization is preferably performed at room temperature for 1 to 100 hours, and the polymerization time may increase as the number of bonds of the phenylene group of the monomer represented by Structural Formula 3 increases. For example, if the monomer is p-terphenyl, polymerization may be made by reacting for 3 to 4 hours at room temperature, and if p-quaterphenyl, reaction is preferably made for 45 to 55 hours at room temperature.

The polymer solution preferably contains 20 to 40 wt % of the ionized polymer, more preferably 25 to 35 wt %, and even more preferably 28 to 32 wt %. When the ionized polymer content is less than 20 wt %, the shape of a coating layer may be damaged in a process of immersing in a non-solvent immediately after coating, and when it exceeds 40 wt %, the viscosity of the polymer solution may become too high, making it difficult to coat the substrate.

Next, the polymer solution is coated on the substrate to produce a substrate on which a polymer solution coating layer is formed (step b).

The polymer solution coating layer is preferably formed to a thickness of 50 to 400 μm, and more preferably, may be formed to a thickness of 100 to 200 μm. The thickness of a membrane to be formed may be controlled by controlling the thickness and concentration of the polymer solution coating layer.

The coating may be performed by any one scheme selected from doctor blade, spin coating, dip coating, and spray coating.

Next, the substrate on which the polymer solution coating layer is formed is immersed in a non-solvent without going through a drying process under elevated temperature conditions to form an ionized polymer membrane (step c).

The non-solvent may be one selected from water, methanol, ethanol, propanol, and butanol, preferably one selected from water, methanol, and ethanol, and more preferably water may be used.

The significance of the disclosure lies in the fact that, under the condition of using the non-solvent together with the polymer and organic solvent used in the previous step, the membrane produced by solution casting (SC) undergoing a temperature-increased drying process while undergoing a non-solvent-induced phase separation (NIPS) process that does not undergo a drying process after polymer solution coating may have the properties and structure of a membrane.

Therefore, if any one of the above-described polymers and organic solvents is not satisfied, the membrane may become cloudy due to phase separation by the process of immersing the polymer solution coating layer in the non-solvent without drying, or a polymer membrane having an uneven porous structure may be formed instead of a non-porous, dense, and transparent membrane, which is not preferable.

The non-solvent induced film formation (NIFF) process used in the disclosure, unlike the conventional solution casting (SC) process, may quickly and simply produce a high-density polymer film by simple immersing in a non-solvent without a drying process of the polymer solution coating layer, so it is very efficient in terms of process time and energy savings. In contrast, when forming a polymer coating layer through the conventional solution casting (SC) process, it takes a long time to completely remove the residual solvent to produce a dense film, and multi-stage high-temperature vacuum treatment is required, so it is disadvantageous in process efficiency compared to the disclosure.

In addition, the non-solvent induced film formation (NIFF) process used in the disclosure may form a dense, non-porous polymer membrane without bubbles or defects of self-assembly, despite using the same method as the non-solvent induced phase separation (NIPS) process. In contrast, the conventional non-solvent induced film formation (NIFF) process causes phase separation when the polymer solution is immersed in the non-solvent, causing the membrane to become cloudy and forming an uneven porous membrane.

The coating layer of the polymer solution may form a gel region by gelation at the contact surface with the non-solvent.

The gel region is characterized by preventing the non-solvent from penetrating into the polymer and allowing the organic solvent to escape from the polymer. In the NIFF process, the liquid-liquid phase separation phenomenon does not occur when a non-solvent is added, and the gel layer formed at the interface not only blocks the non-solvent from entering and exiting but also allows the solvent in the polymer solution to quickly escape out of the system, so that a non-porous, dense structure may be easily formed.

Afterwards, after the ionized polymer membrane is spontaneously separated from the substrate, ion-exchanging a counter ion of the ionized polymer membrane may be performed (step d).

The ion exchange is preferably performed by adding sodium chloride (NaCl) or sodium hydroxide (NaOH) to exchange the counter ion with a chloride ion (Cl⁻) or a hydroxide ion (OH⁻).

Most preferably, the method for producing a self-assembly polymer membrane by non-solvent induced film formation (NIFF) of the disclosure may use, in step (a), quaternized poly(aryl piperidinium) (q-PAP) represented by Structural Formula 1, quaternized poly(terphenyl piperidinium) (q-PTP), or quaternized poly(quaterphenyl piperidinium) (q-PQP), and dimethyl sulfoxide (DMSO) is used as the organic solvent, and water may be used as the non-solvent of (c).

When such conditions are satisfied, unlike when using other polymers, organic solvents, and non-solvents, no thermal weight loss occurs up to 200° C., making this very suitable for use in fuel cells and water electrolysis. In addition, even if this is produced as a thin membrane of 15 um or less, this has the effect of significantly improving ion conductivity when applied as an anion exchange membrane, since this shows the same level of tensile strength and elongation at break compared to the membrane produced using the conventional solution casting (SC) process of Comparative Example.

The disclosure provides a polymer membrane produced according to the method of producing a self-assembly polymer membrane by non-solvent induced film formation (NIFF).

The polymer membrane may be used as an ion exchange membrane, and preferably may be used as an anion exchange membrane (AEM).

The disclosure provides an electrochemical device including the polymer membrane.

The electrochemical device may be one selected from an alkaline water electrolysis device, a redox flow battery, and a fuel cell, but the disclosure is not limited thereto and may be applied to various devices to which a nonporous high-density membrane is applicable.

Hereinafter, an Example according to the disclosure will be described in detail.

### EXAMPLE

### Production Example 1-1: Poly(terphenyl piperidinium) (PTP) Synthesis

A magnetic stirrer bar was placed in a round bottom flask, and 4.606 g of p-terphenyl and 2.706 [symbol] of N-methyl-4-piperidone were dissolved in 20 [symbol] of dichloromethane. Then, the round bottom flask was immersed in an ice bath, and while 2 [symbol] of trifluoroacetic acid and 17.66 [symbol] of trifluoromethanesulfonic acid were slowly added, the polymerization reaction was performed at room temperature (25° C.) for 3 hours. After the polymerization reaction, the polymer solution was washed three times in distilled water by precipitation to obtain poly(terphenyl piperidinium) (PTP).

### Production Example 1-2: Quaternized PTP (q-PTP) Production

According to Production Example 1-1, 0.4 g of the polymer poly(terphenyl piperidinium) (PTP) synthesized and 10 [symbol] of DMSO were first added to a vial, and then 0.2 [symbol] of CH₃I and 0.3 g of K₂CO₃ (acid-binding agent) were additionally added. The vial was covered with aluminum foil to block light, and stirred at room temperature for 24 hours to perform the Menshutkin reaction. After the reaction, the polymer solution was precipitated in a diethyl ether solvent, washed three times, and then washed three times in distilled water to remove inorganic substances. Next, a polymer was obtained through a vacuum filter, and dried at 50° C. for 24 hours to produce the quaternized PTP (q-PTP) polymer.

### Production Example 2-1: POP (poly(quaterphenyl piperidinium)) Synthesis

Poly(quaterphenyl piperidinium) (PQP) was obtained in the same manner as Production Example 1-1, except that 6.128 g of p-quaterphenyl was used instead of 4.606 g of p-terphenyl, and the polymerization reaction was performed for 48 hours instead of 3 hours.

### Production Example 2-2: Quaternized POP (q-POP) Production

A quaternized PQP (q-PQP) polymer was produced under the same conditions as Example 2-1, except that the poly(terphenyl piperidinium) (PTP) polymer synthesized according to Production Example 1-1 was used instead of the poly(quaterphenyl piperidinium) (PQP) polymer synthesized according to Production Example 2-1.

Reaction Formula 1 below shows the production process of q-PTP (a) and q-PQP (b) according to an Example. The substitution of an I-counterion with OH-by ion exchange may occur after membrane formation.

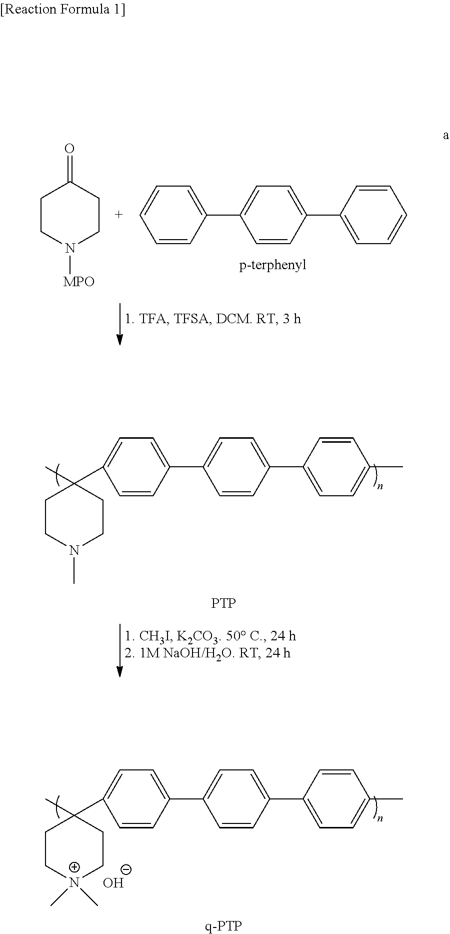

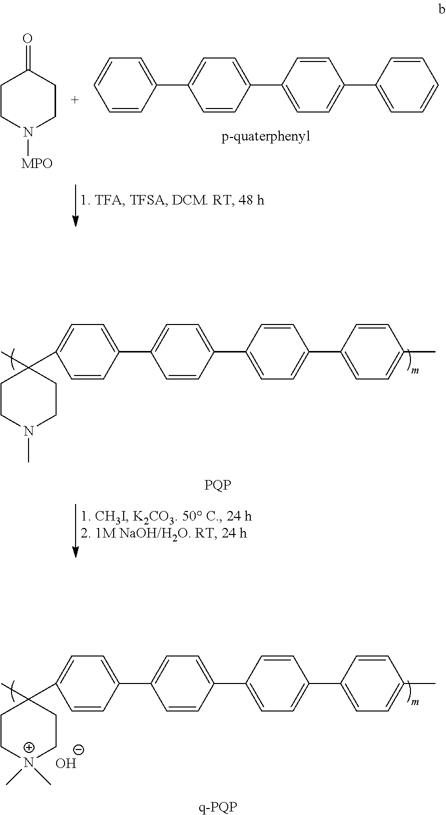

### Production Example 3-1: Poly (4-vinylbenzyl-b-styrene) Production

A poly(4-vinylbenzyl-b-styrene) (PVBC-b-PS) block copolymer represented by Structural Formula 4 is produced by performing reversible addition-fragmentation chain transfer polymerization.

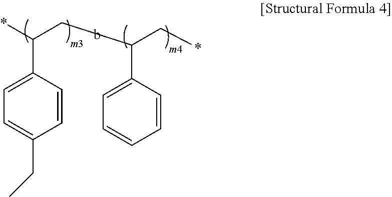

In Structural Formula 4,
10 m3 and m4 are each independently a repeating unit number, which is an integer from 20 to 150.

### Production Example 3-2: Quaternized poly(4-vinylbenzyl-b-styrene) Production

Poly(4-vinylbenzyl-b-styrene)(PVBC-b-PS) produced according to Production Example 3-1 is reacted with triethylamine to produce a quaternized poly(4-vinylbenzyl-b-styrene) (PVBC-b-PS)(q-PVBC-b-PS) block copolymer represented by Structural Formula 5.

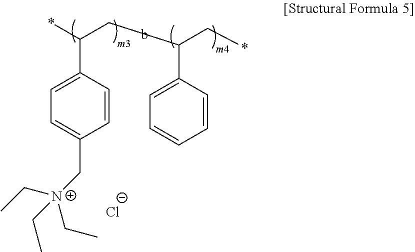

In Structural Formula 5,
m3 and m4 are each independently a repeating unit number, which is an integer from 20 to 150.

### Example 1: g-PTP Membrane Production Through Non-Solvent Induced Film Formation (NIFF) Process

The q-PTP polymer produced according to Production Example 1-2 was dissolved in a DMSO solvent to 30 wt % to produce a high-concentration polymer solution. The q-PTP polymer solution was coated on a glass substrate using a doctor blade. The coated glass substrate was placed in a water-based non-solvent coagulation bath at room temperature. Upon contact with water, the q-PTP polymer solution coating layer forms a transparent and dense membrane and spontaneously detaches from the glass substrate. Finally, to change a counter ion of the produced membrane to OH⁻, ion exchange was performed in a 1M NaOH solution for 24 hours.

### Example 2: q-POP Membrane Production Through Non-Solvent Induced Film Formation (NIFF) Process

A q-PQP membrane was produced in the same manner as Example 1, except that the q-PQP polymer produced according to Production Example 2-2 was used instead of the q-PTP polymer produced according to Production Example 1-2.

### Example 3: q-PVBC-b-PS Membrane Production Through Non-Solvent Induced Film Formation (NIFF) Process

A q-PVBC-b-PS membrane was produced in the same manner as Example 1, except that the q-PVBC-b-PS block copolymer produced according to Production Example 3-2 was used instead of the q-PTP polymer produced according to Production Example 1-2.

### Comparative Example 1: q-PTP Membrane Production Through Solution Casting (SC) Process

The q-PTP polymer produced according to Production Example 1-2 was dissolved in a DMSO solvent to 10 wt % to produce a q-PTP polymer solution. The q-PTP polymer solution was coated on a glass substrate using a doctor blade. To evaporate the DMSO solvent, drying was performed at 80° C. for 24 hours. Afterwards, the dried substrate was placed in distilled water to produce a membrane, and ion exchange was performed in a 1M NaOH solution for 24 hours to change a counter ion of the produced membrane to OH⁻.

### Comparative Example 2: q-PTP Membrane Production Through Solution Casting (SC) Process

A q-PQP membrane was produced in the same manner as Comparative Example 1, except that the q-PQP polymer produced according to Production Example 2-2 was used instead of the q-PTP polymer produced according to Production Example 1-2.

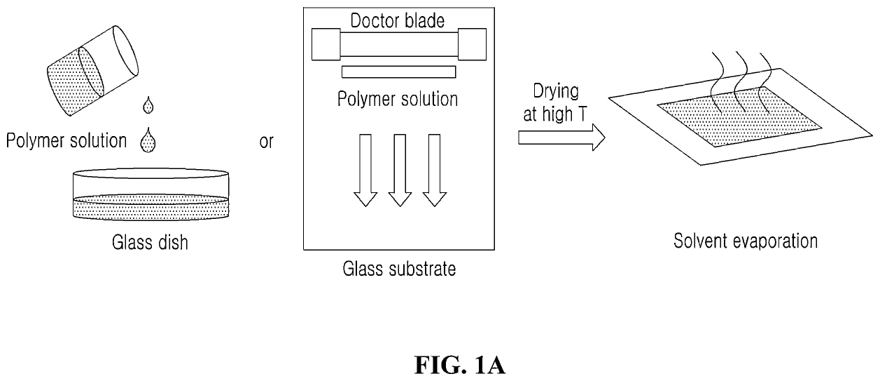

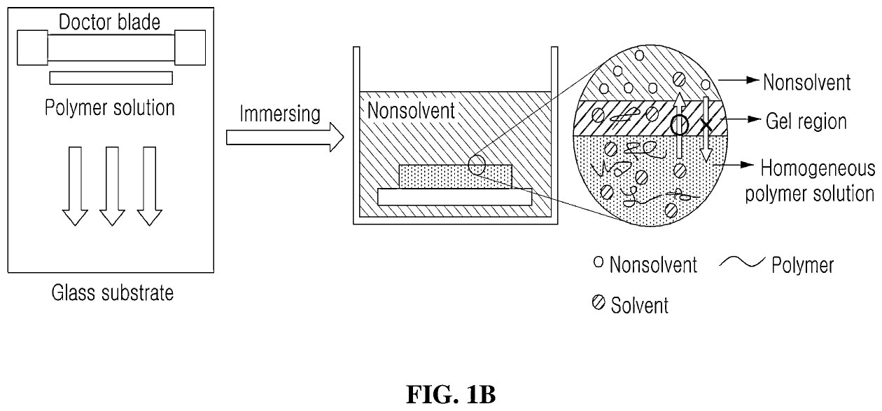

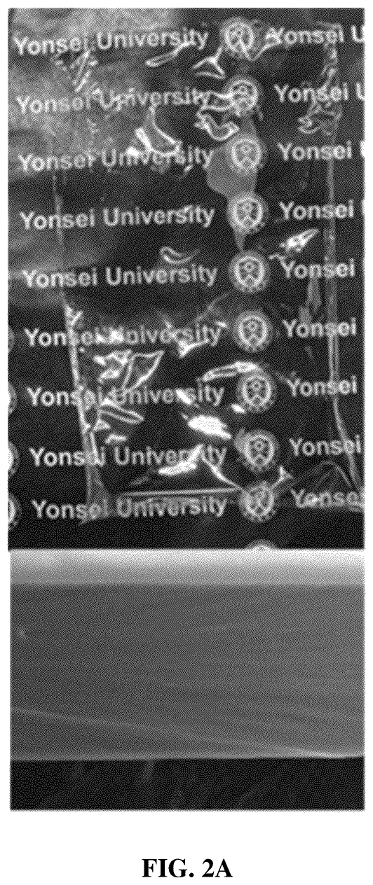

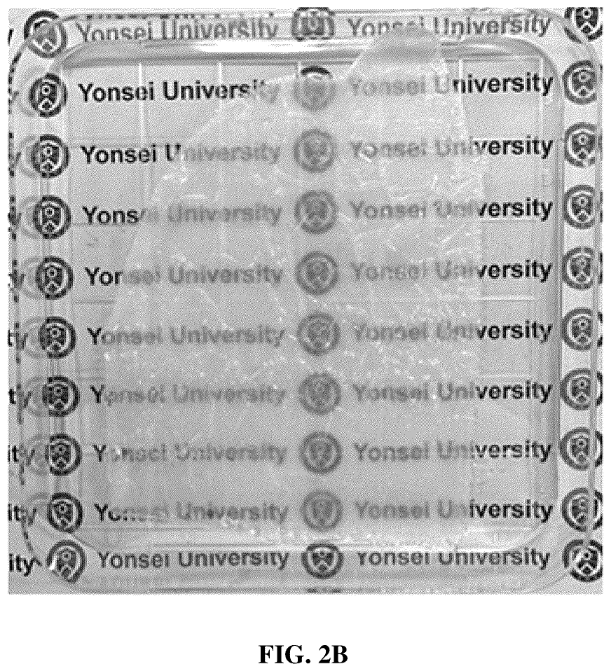

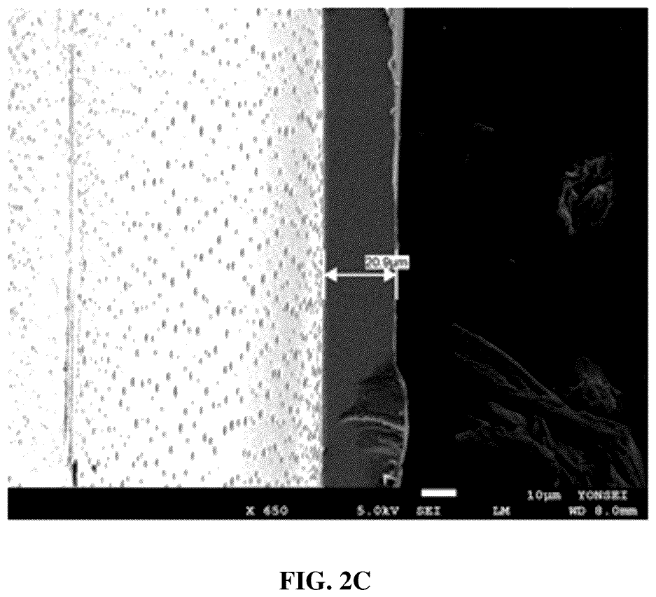

The schematic diagrams of a production process of quaternized poly(aryl piperidinium) (q-PAP) according to the conventional solution casting (SC) of Comparative Examples 1 and 2 (1A) and a production process of quaternized poly(aryl piperidinium) (q-PAP) according to the non-solvent induced film formation (NIFF) of Examples 1 and 2 (1B) are shown in FIGS. 1A and 1B. In addition, FIGS. 2A, 2B, and 2C each shows a photograph of a q-PTP membrane produced according to Example 1 (2A), a photograph of a q-PVBC-b-PS membrane produced according to Example 3 (2B), and a cross-sectional SEM image of a q-PVBC-b-PS membrane.

DMSO used in an Example is an environmentally friendly aprotic solvent, and is widely used in the field of anion exchange membranes due to its advantages of being nontoxic and recyclable. However, because of its high boiling point, using the solution casting (SC) method of Comparative

Examples 1 and 2 requires a lot of time and energy to evaporate the solvent. Therefore, Examples 1 and 2 introduced the non-solvent induced film formation (NIFF) process, and the polymer membranes produced accordingly were transparent, dense, and uniform.

In addition, when examining the cross-sectional SEM image of the q-PVBC-b-PS membrane of Example 3, it was confirmed that a nonporous dense membrane structure with a thickness of 20.9 um was formed. These results indicate that the NIFF process can be applied to various ion-conducting polymer electrolytes produced, such as not only the PAP polymer but also PVBC-b-PS.

### EXPERIMENTAL EXAMPLE

### Experimental Example 1: Ternary Phase Diagram and Dynamic Analysis

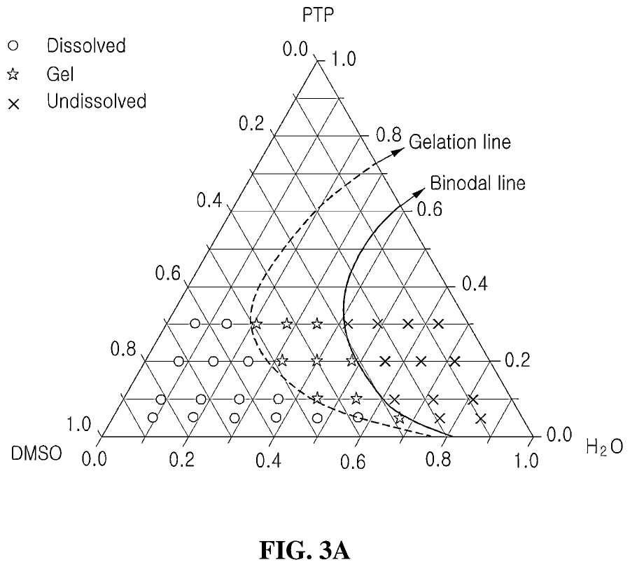

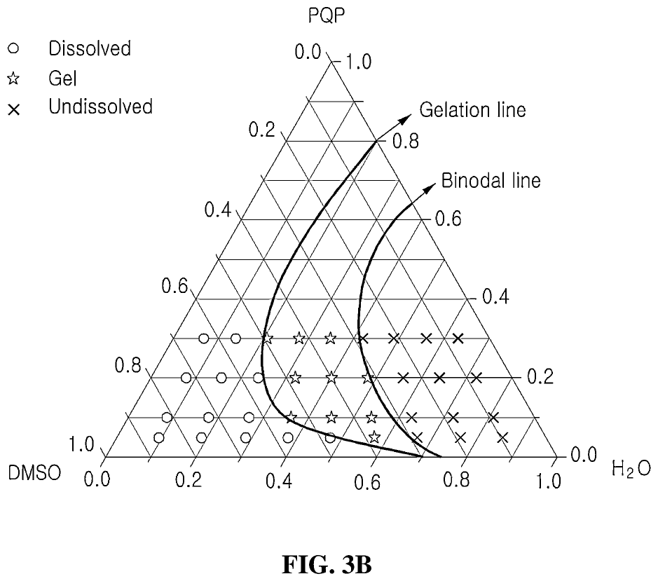

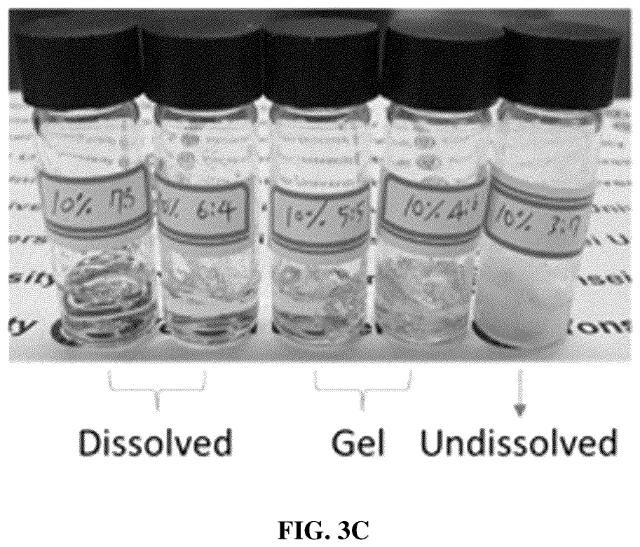

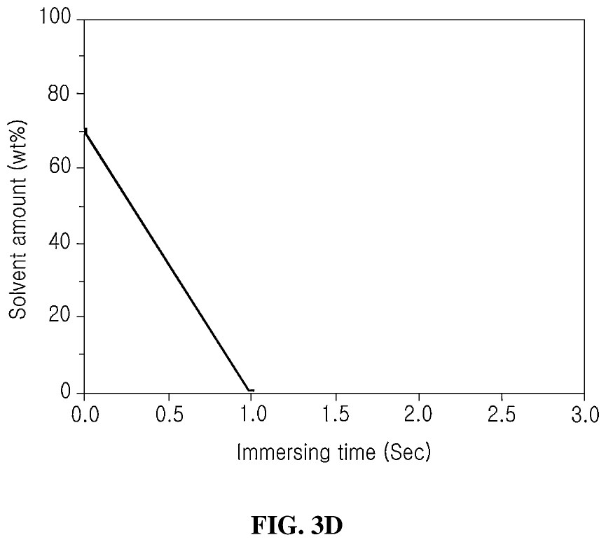

FIGS. 3A, 3B, 3C, and 3D are each a ternary phase diagram and dynamic analysis result of a polymer/solvent/non-solvent system. Here, shown are (3A) PTP/DMSO/water and (3B) PQP/DMSO/water ternary phase diagrams, (3C) a photograph of PTP/DMSO/water systems with 10% concentration and solvent/non-solvent ratios of 7:3, 6:4, 5:5, 4:6, and 3:7, and (3D) the concentration of the DMSO solvent in the polymer solution as a function of precipitation time in the non-solvent (water).

According to FIGS. 3A, 3B, and 3C, the binodal line of the ternary phase diagram was determined as a cloud point, where the solution becomes turbid and heterogeneous. In addition, a transparent gel region was observed between a homogeneous single phase and heterogeneous two phases. Interestingly, the gelation line and binodal line of the PAP (PTP, PQP) ternary phase diagram were very far from the polymer-solvent axis, which means that a wide miscibility gap exists. When general polymers (polyimide, polysulfone, etc.) and polar solvents and water non-solvents are used, the miscibility gap appears very narrow. The PAP system used in the disclosure has high tolerance, and the interaction between the polymer and water is strong, that is, the PAP polymer has a high affinity for the non-solvent (water), and also has a strong affinity between DMSO and water. In addition, the miscibility gap of the PTP polymer was wider than that of the PQP polymer, which shows that PTP is a water-friendly polymer and has higher hydrophilicity than PQP. In addition, when the ionized q-PAP polymer was used, it was observed that a ternary phase diagram was formed similar to that of the general PAP.

Through this analysis, it was confirmed that when the polymer solution was put into a water tank during the non-solvent induced film formation (NIFF) process, this gelled and maintained a homogeneous state. In this process, the non-solvent water was prevented from penetrating into the polymer, and the solvent was able to quickly escape from the gel state.

The above phenomenon was confirmed through the dynamic analysis of the solvent in the non-solvent induced film formation (NIFF) process in FIG. 3D. According thereto, the weight ratio (wt %) of the DMSO solvent in the polymer solution was shown to decrease from 70% to 0% in 1 second, confirming that the NIFF process occurred very quickly.

### Experimental Example 2: Analysis of Interaction Coefficient (c) Between Water and PAP Polymer

Meanwhile, Table 1 below summarizes various parameters for calculating an interaction coefficient (interaction parameter, χ) between water and a PAP polymer.

TABLE 1

| | | | Polymer | |
|---|---|---|---|---|
| | Density | Water uptake | volume fraction | |
| Polymer | (g mL⁻¹) | (%) | (ϕ₃) | χ |
| PTP | 1.5065 | 9.46 | 0.864 | 1.52 |
| PQP | 1.5325 | 8.12 | 0.881 | 1.61 |

The volume fraction, density, and water-swelling ratio of a polymer were investigated, and the interaction coefficient (χ) was calculated according to the Flory-Rehner theory. The interaction coefficients (χ) of PTP and PQP polymers were 1.52 and 1.61, respectively, which were significantly lower than the interaction coefficients (χ), about 2 to 3, of general polymers, indicating that the interaction between the PAP polymer and water was very strong. In addition, PTP showed a slightly lower interaction coefficient (χ) than PQP, which indicated that PTP had greater water-affinity as confirmed in the ternary phase diagrams of FIGS. 3A, 3B, 3C, and 3D. The low interaction coefficient (χ) of the PAP polymer was shown by the wide miscibility gap in the ternary phase diagram. Meanwhile, the interaction coefficient (χ) of PAP was similar to that of cellulose acetate (1.66), a representative hydrophilic polymer. During the membrane production process of the disclosure, the PAP polymer forms a gel region in a ternary system with a specific ratio and does not undergo a phase transition process. Therefore, unlike the cellulose acetate system, the PAP polymer may form a transparent and dense membrane without undergoing a phase separation process.

### Experimental Example 3: TEM, FTIR and TGA Analyses on q-PAP Polymer

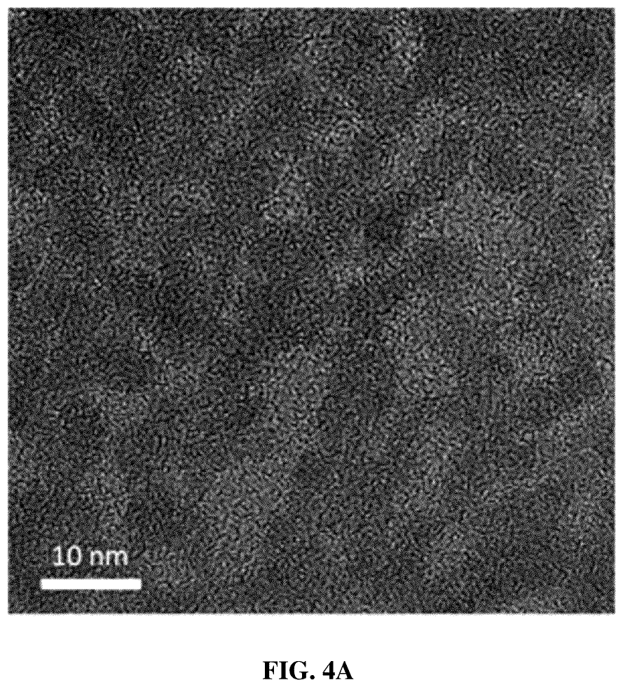

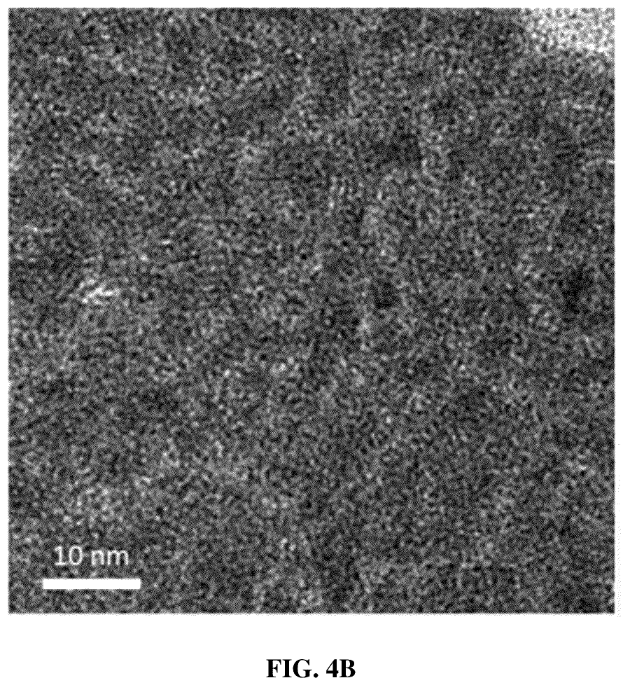

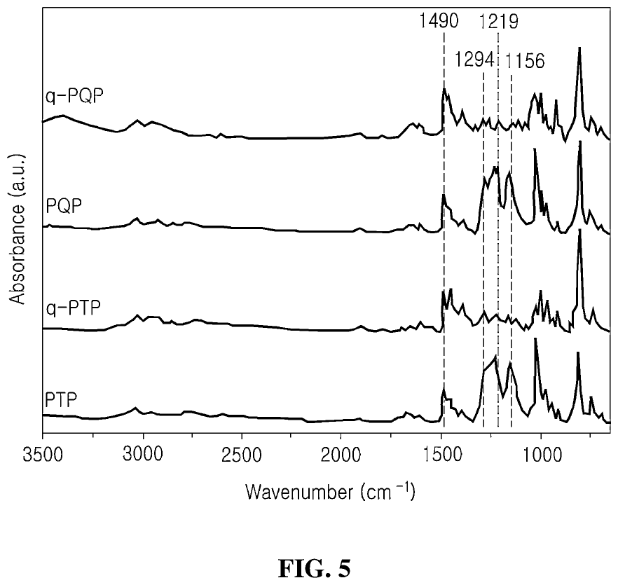

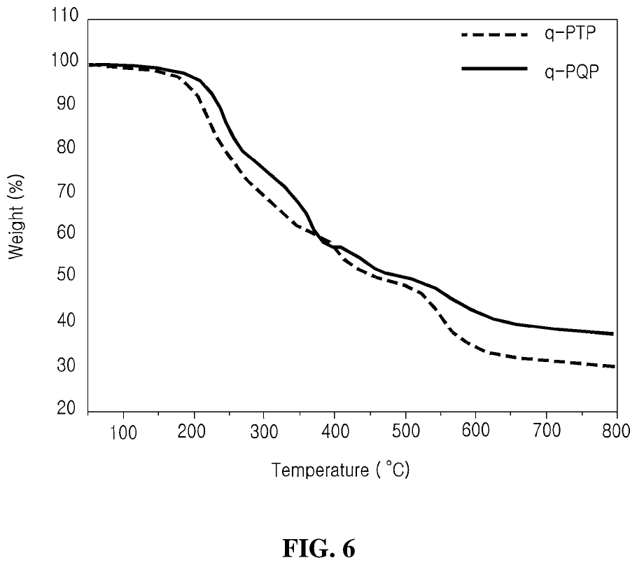

FIGS. 4A and 4B show a TEM image (4A) of a q-PTP polymer and a TEM image (4B) of a q-PQP polymer, FIG. 5 shows FTIR spectra of PTP, q-PTP, PQP, and q-PQP polymers, and FIG. 6 shows TGA graphs of q-PTP and q-PQP polymers.

According to FIGS. 4A and 4B, the microphase separation structure of the q-PAP polymer was confirmed by transmission electron microscopy (TEM). The phase separation structure of ionic hydrophilic and hydrophobic domains is an essential characteristic of anion exchange membranes (AEMs), which promotes ion transport and affects the stability of the membrane. The bright region in the TEM image represents a hydrophobic aryl group of the base polymer q-PAP, and the dark region represents a hydrophilic quaternary ammonium group. Both q-PTP and q-PQP polymers showed distinct phase separation structures.

According to FIG. 5, a graph analyzing the synthesis of PAP and q-PAP by Fourier transform infrared spectroscopy (FTIR) was shown, and the characteristic absorption bands of each monomer were clearly observed in the synthesized polymers. In particular, it was observed that the absorption band of the C—N bond of PAP shifted well in the q-PAP spectrum, indicating that the polymer was successfully synthesized.

According to FIG. 6, the thermal stability of the q-PAP polymer was investigated through a thermogravimetric analyzer (TGA) graph, and the first weight loss of the polymer between 200 and 350° C. indicates the decomposition of the functionalized piperidine group. The second decomposition stage started at 400° C. or less, indicating the decomposition of the arylene group of the base polymer. Through TGA analysis, it was observed that both q-PTP and q-PQP had high thermal stability up to 200° C. Therefore, it was confirmed that q-PTP and q-PQP are suitable for application in the fields of fuel cells and water electrolysis.

### Experimental Example 4: SEM Images, Mechanical Properties and OH-Conductivity Analysis of q-PAP Membrane

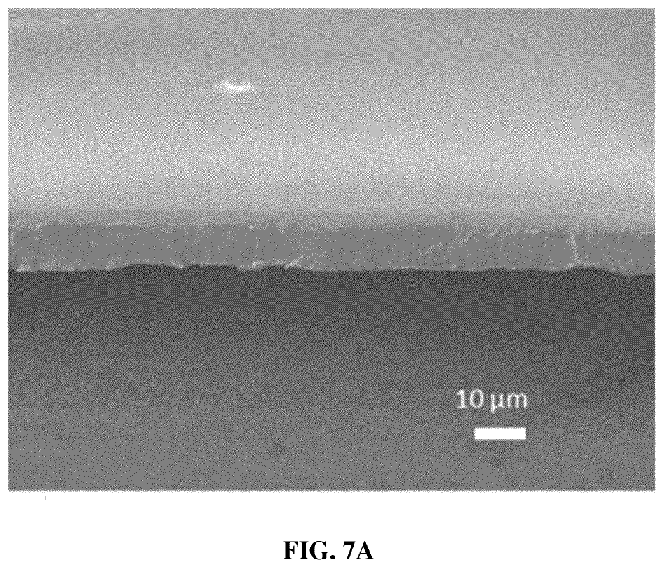

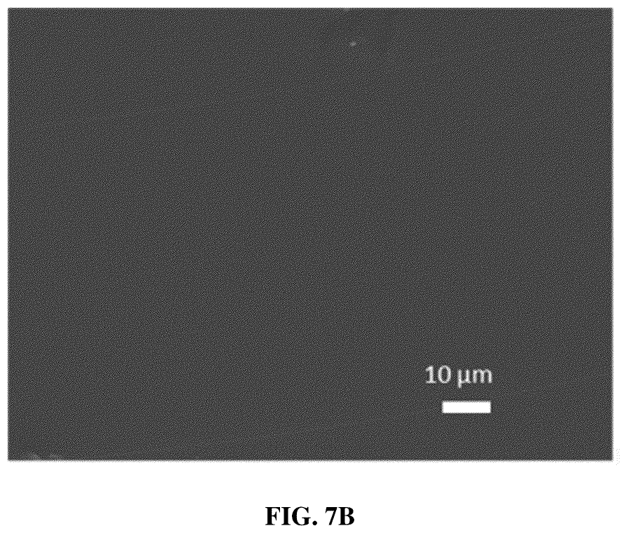

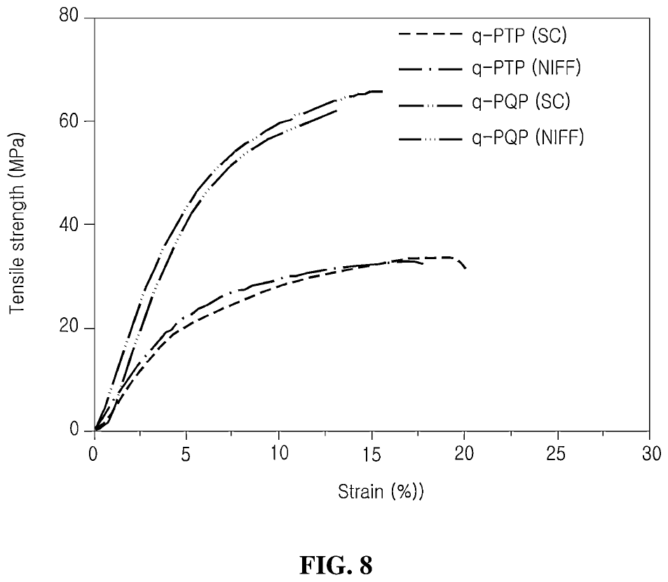

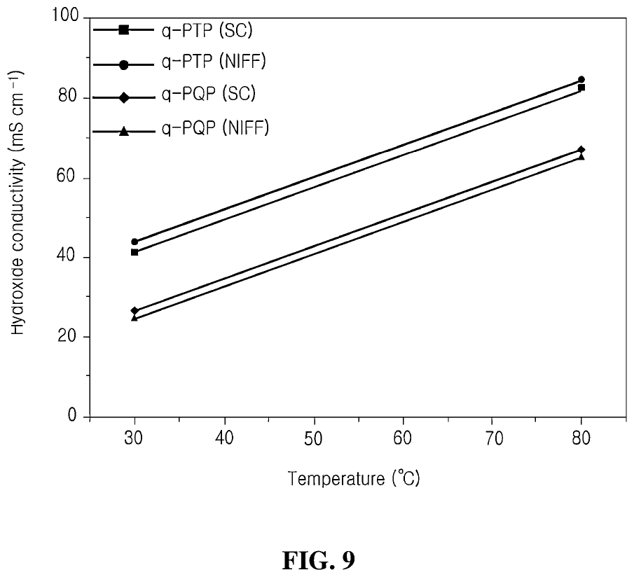

FIGS. 7A and 7B show an SEM image (7A) of the cross-section of a q-PQP membrane and an SEM image (7B) of the surface of a q-PQP membrane, FIG. 8 is a stress-strain curve for a q-PAP membrane, and FIG. 9 is hydroxide ion (OH⁻) conductivity measurement results of NIFF-based q-PAP membranes of Examples 1 and 2 and SC-based q-PAP membranes of Comparative Examples 1 and 2.

According to FIGS. 7A and 7B, the cross-section and surface images of the q-PQP membrane produced by the non-solvent induced film formation (NIFF) scheme were obtained by scanning electron microscopy (SEM), wherein there was no morphological difference between the solution casting (SC) of a Comparative Example and the non-solvent induced film formation (NIFF)-based membrane of an Example in the SEM image. That is, no pores or voids were observed in the cross- section and surface of both membranes. This indicates that non-homogeneous phase separation does not occur when the membrane is formed in the NIFF process.

According to FIG. 8, the mechanical properties of the q-PAP membrane produced by the NIFF process of Examples 1 and 2 and the q-PAP membrane produced by the SC process of Comparative Examples 1 and 2 were measured using a universal testing machine (UTM), wherein despite their thin thickness (˜15 μm), all q-PAP membranes showed high tensile stress and appropriate elongation at break, indicating significant mechanical strength. In addition, the mechanical properties (strength and strain) of the SC and NIFF-based membranes were at similar levels, which was consistent with the visual and morphological similarities. In addition, due to the high rigidity of four phenyl groups of q-PQP, the tensile strength of the q-PQP membrane was found to be higher than that of the q-PTP membrane.

FIG. 9 is a graph showing the hydroxide ion conductivity of the q-PAP membrane produced by the NIFF process of Examples 1 and 2 and the q-PAP membrane anion exchange membrane (AEM) produced by the SC process of Comparative Examples 1 and 2, measured at 30° C. and 80° C. The q-PTP membrane anion exchange membrane (AEM) of Example 1 and the q-PQP membrane anion exchange membrane (AEM) of Example 2 produced by the NIFF process showed similar ion conductivity to the solution casting (SC)-based membrane anion exchange membranes (AEMs) of Comparative Examples 1 and 2, respectively. That is, the NIFF process is a very efficient membrane production method, as the process is simple and saves energy compared to the solution casting (SC) process, but the results show a similar level of performance.

### Experimental Example 5: Analysis of Electrochemical Properties of q-PAP Membrane

Table 2 below summarizes various electrochemical properties of q-PAP membranes produced through SC and NIFF.

TABLE 2
*210

| | Theoretical | Measured | Water | Swelling | |
|---|---|---|---|---|---|
| | IEC | IEC | uptake | ratio | |
| AEM | (mmol g⁻¹) | (mmol g⁻¹) | (WU; %) | (SR; %) | λ |
| q-PTP(SC) | 2.65 | 2.62 | 73.1 | 19.7 | 15.5 |
| q-PTP(NIFF) | | | 72.7 | 20.2 | 15.4 |
| q-PQP(SC) | 2.21 | 2.18 | 41.9 | 12.9 | 10.7 |
| q- | | | 41.3 | 13.5 | 10.5 |
| PQP(NIFF) | | | | | |

The ion exchange capacity (IEC) of the membrane is an important parameter that directly affects the dimensional stability and ion conductivity. In general, a high IEC value improves the mobility of ions, but has the disadvantage of increasing the water absorption rate of the membrane and deteriorating the mechanical properties of the membrane. The ion exchange capacity (IEC) of the q-PTP membrane of Example 1 and the q-PQP membrane of Example 2, measured using the Mohr titration method, each was 2.62 and 2.18 mmol g⁻¹, which were in good agreement with the theoretical ion exchange capacity (IEC) values, confirming the successful quaternization of the PAP membrane.

In addition, the dimensional stability of the produced anion exchange membrane (AEM) was evaluated by comparing the swelling ratio of the hydrated membrane and the dried membrane at 25° C. A membrane with high ion exchange capacity (IEC) showed high water uptake and swelling ratio (SR) values. The NIFF-based q-PAP membranes of Examples 1 and 2 were confirmed to have dimensional stability equivalent to that of the SC-based membranes of Comparative Examples 1 and 2.

In addition, the hydration number (2) of the q-PAP membranes of Examples 1 and 2 was investigated. It was found that as the number of phenyl segments in the q-PAP polymer increased, 5 the number of water molecules absorbed by the quaternary ammonium group decreased.

Although the embodiments of the disclosure have been described above, those skilled in the art may add, change, delete or supplement components without departing from the spirit of the disclosure as set forth in the claims to modify and change the disclosure in various ways, and this 10 will also be included within the scope of rights of the disclosure.

What is claimed is:

1. A method for producing a self-assembly polymer membrane by non-solvent induced film formation (NIFF), the method comprising:
(a) preparing a polymer solution by mixing an ionized polymer with an organic solvent;
(b) preparing a substrate on which a polymer solution coating layer is formed by coating the polymer solution on the substrate; and
(c) forming an ionized polymer membrane by immersing the substrate on which the polymer solution coating layer is formed in a non-solvent without going through a drying process under elevated temperature conditions.

2. The method of claim 1, wherein in (a), the organic solvent has a boiling point of 150° C. or higher and is selected from a group consisting of dimethyl sulfoxide (DMSO), dimethylformamide (DMF), N-methyl-2-pyrrolidone (NMP), and dimethylacetamide (DMAC).

3. The method of claim 1, wherein the ionized polymer is an ionized form of a polymer of one selected from poly(aryl piperidinium), poly(4-vinylbenzyl-b-styrene) (PVBC-b-PS), poly(ethylene oxide) (PEO), poly(vinyl alcohol) (PVA), poly(2,6-dimethyl-1,4-phenylene oxide) (PPO), polyethylene (PE), polypropylene (PP), polychloromethylstyrene (PCMS), poly(epichlorohydrin), poly(acrylic acid) (PAA), chitosan, polybenzimidazole (PBI), poly(vinylbenzyl chloride) (PVBC), poly(γ-methacryloxypropyl trimethoxy silane), poly(methyl acrylate) (PMA), polyethyleneimine (PEI), poly(styrenesulfonic acid) (PSSH), polycarylonitrile (PAN), polyphenylene, polyethersulfone (PES), polysulfone (PSF), and nafion.

4. The method of claim 3, wherein the ionized polymer is a quaternized poly(aryl piperidinium) (q-PAP) represented by Structural Formula 1: 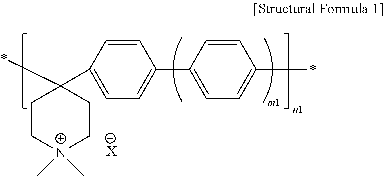
wherein in the Structural Formula 1,
m1 is a repeating unit number, which is an integer from 1 to 10,
n1 is a repeating unit number, which is an integer from 50 to 200, and
X⁻ is a hydroxide ion (OH⁻) or a chloride ion (Cl⁻).

5. The method of claim 4, wherein in the Structural Formula 1, the m1 is the repeating unit number of 2 or 3, the n1 is the repeating unit number from 100 to 150, and the X⁻ is the hydroxide ion (OH⁻) or the chloride ion (Cl⁻).

6. The method of claim 4, wherein in (a), the quaternized poly(aryl piperidinium)(q-PAP) is produced according to a Menshutkin reaction by adding a halogenated alkyl to poly(aryl piperidinium)(PAP) represented by Structural Formula 2: 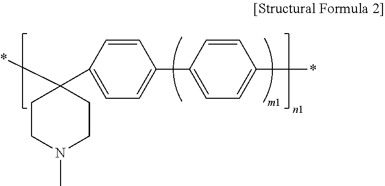
wherein in the Structural Formula 2,
the m1 is the repeating unit number, which is the integer from 1 to 10, and
the n1 is the repeating unit number, which is the integer from 50 to 200.

7. The method of claim 6, wherein the poly(aryl piperidinium) (PAP) represented by the Structural Formula 2 is polymerized under an acid catalyst according to a Friedel-Crafts condensation reaction with N-methyl-4-piperidone using a monomer represented by Structural Formula 3: 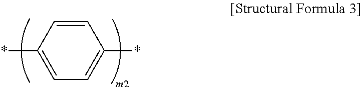
wherein in the Structural Formula 3, m2 is the repeating unit number, which is the integer from 2 to 10.

8. The method of claim 7, wherein the monomer represented by the Structural Formula 3 is p-terphenyl or p-quaterphenyl.

9. The method of claim 3, wherein the ionized polymer is a quaternized poly(4-vinylbenzyl-b-styrene) (PVBC-b-PS) block copolymer represented by Structural Formula 5: 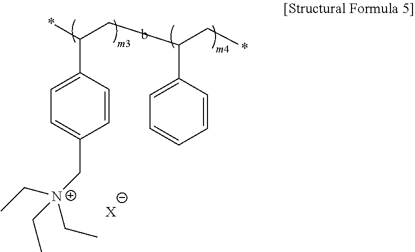
wherein in the Structural Formula 5,
m3 and m4 are each independently a repeating unit number, which is an integer from 20 to 150, and
X⁻ is a hydroxide ion (OH⁻) or a chloride ion (Cl⁻).

10. The method of claim 7, wherein the acid catalyst includes trifluoroacetic acid and trifluoromethanesulfonic acid.

11. The method of claim 1, wherein in (a), the polymer solution contains 20 to 40 wt % of the ionized polymer.

12. The method of claim 1, wherein the organic solvent of (a) is dimethyl sulfoxide (DMSO), and the non-solvent of (c) is water.

13. The method of claim 1, wherein in (b), the polymer solution coating layer has a thickness of 50 to 400 μm.

14. The method of claim 1, wherein in (b), the coating is applied by any one scheme selected from doctor blade, spin coating, dip coating and spray coating.

15. The method of claim 1, wherein in (c), the coating layer of the polymer solution forms a gel region by gelation at a contact surface with the non-solvent.

16. The method of claim 15, wherein the gel region configured to prevent the non-solvent from penetrating into the ionized polymer and allow the organic solvent to escape from the ionized polymer.

17. The method of claim 1, further comprising, after (c), (d) ion-exchanging a counter ion of the ionized polymer membrane after the ionized polymer membrane is spontaneously separated from the substrate.

18. The method of claim 17, wherein the ion exchanging exchanges the counter ion with a chloride ion (Cl⁻) or hydroxide ion (OH⁻) by adding sodium chloride (NaCl) or sodium hydroxide (NaOH).

19. A polymer membrane produced according to the method for producing the self-assembly polymer membrane by the non-solvent induced film formation (NIFF) of claim 1.

20. The polymer membrane of claim 19, wherein the polymer membrane is used as an ion exchange membrane.

21. The polymer membrane of claim 20, wherein the ion exchange membrane is an anion exchange membrane (AEM).

22. An electrochemical device comprising the polymer membrane of claim 19.

23. The electrochemical device of claim 22, wherein the electrochemical device is one selected from an alkaline water electrolysis device, a redox flow battery, and a fuel cell.
